(19) United States
(12) Patent Application Publication
(10) Pub. No.: US 2007/0166644 A1
(43) Pub. Date: Jul. 19, 2007

(54) Photoresist composition and method of forming a photoresist pattern using the same

(76) Inventors: Boo-Deuk Kim, Gyeonggi-do (KR); Hyo-Jin Yun, Gyeonggi-do (KR); Young-Gil Kwon, Gyeonggi-do (KR); Young-Ho Kim, Gyeonggi-do (KR); Jin-A Ryu, Seoul (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/655,158

(22) Filed: Jan. 19, 2007

(30) Foreign Application Priority Data
Jan. 19, 2006 (KR) 2006-5676

(51) Int. Cl. G03C 1/00

(52) U.S. Cl. 430/270.1

(57) ABSTRACT

In one aspect, a photoresist composition includes a cross-linking agent, a photosensitive material, an organic solvent, and a compound having a chemical structure represented by formulae (1) or (2) herein. The cross-linking agent includes at least one epoxy group and/or at least two hydroxyl groups.

### BACKGROUND OF THE INVENTION

1. Field of the Invention

Example embodiments of the present invention relate to a photoresist composition and to a method of forming a photoresist pattern using the same.

A claim of priority under 35 U.S.C. § 119 is made to Korean Patent Application No. 2006-5676 filed on Jan. 19, 2006, the contents of which are herein incorporated by reference in their entireties.

2. Description of the Related Art

Photolithography is commonly utilized in the fabrication of semiconductor devices. In photolithography, a photoresist pattern is formed using a photoresist composition. The photoresist composition is generally prepared by mixing a photosensitive material that is reactive with light to generate an acid, a polymer having an acid-labile group and a solvent. The solubility of the photoresist composition in a developing solution is different before and after exposure to light. Thus, after a photoresist film is formed on an object using the photoresist composition, the photoresist film is exposed to light through a mask and developed. As a result, a photoresist pattern having a predetermined shape or image is formed on the object.

A photoresist is generally classified as either a positive photoresist or a negative photoresist based on solubility in a developing solution. In a positive photoresist, a light-exposed portion has a high solubility in the developing solution. Thus, the light-exposed portion of the positive photoresist is easily removed in a developing process, and in this manner a pattern having a predetermined image is obtained. On the other hand, a light-exposed portion of a negative photoresist has a low solubility in the developing solution. Thus, an unexposed portion of the negative photoresist is removed in the developing process, and a pattern having a predetermined image is thereby obtained.

The polymers contained in the photoresist compositions may be considered the building blocks of the photoresist layer. As the patterns of semiconductor devices are fabricated with finer dimensions, the line widths of the patterns have approached a molecular size of the polymers included in the photoresist composition. The polymers have relatively large molecular sizes, and thus the building blocks of the photoresist layer are relatively large. This limits the ability to further reduce the line widths of patterns formed using the polymer-based photoresist compositions.

FIGS. 1 and 2 are conceptional views illustrating a photoresist pattern formed using a polymer-based photoresist composition. In these figures, reference number 10 denotes an object to be patterned, and reference number 12 denotes a mask. Further, in FIG. 1, reference number 13 denotes light energy, and reference number 11a denotes a photoresist film formed of polymeric building blocks, where the light exposed building blocks are cross-hatched in the drawing. In FIG. 2, reference number 11b denotes the photoresist film after a development process in which the light exposed polymeric building blocks have been removed.

Referring to FIGS. 1 and 2, when the photoresist pattern is formed using a polymer-based photoresist composition, the relatively large size of the polymeric building blocks of the photoresist layer can result in a photoresist pattern having a rough line width and a nonuniform thickness. Therefore, the photoresist composition cannot be readily adapted to form a fine pattern having a molecular level resolution.

In addition, polymers of the photoresist compositions exhibit various molecular sizes (i.e., a molecular weight distribution), chain entanglement, and variable solubility in developing solution depending on molecular size. The polymers also swell easily in a developing solution. Thus, when the photoresist pattern is formed using a polymer-based photoresist composition, a line width roughness can be substantially worsened in a developing process.

In an effort to overcome the problems associated with polymer-based photoresist compositions, a molecular photoresist has been developed which includes a low molecular weight compound having a definite structure and a single molecular weight is utilized as a building block instead of a polymer. The building block of this molecular photoresist is substantially smaller than that of the polymer-based photoresist. Thus, the molecular photoresist exhibits only slight or substantially no entanglement between molecules, and thus may be adapted to form a fine pattern having molecular level resolution and to reduce a line width roughness of a pattern. However, the molecular photoresist also exhibits a weak binding force between molecules, and therefore a photoresist pattern formed using the molecular photoresist is characterized by poor etching resistance in an etching process.

### SUMMARY OF THE INVENTION

According to one aspect of the present invention, a photoresist composition includes a cross-linking agent having at least one epoxy group and/or at least two hydroxyl groups, a photosensitive material, an organic solvent, and a compound having a chemical structure represented by formulae (1) or (2),

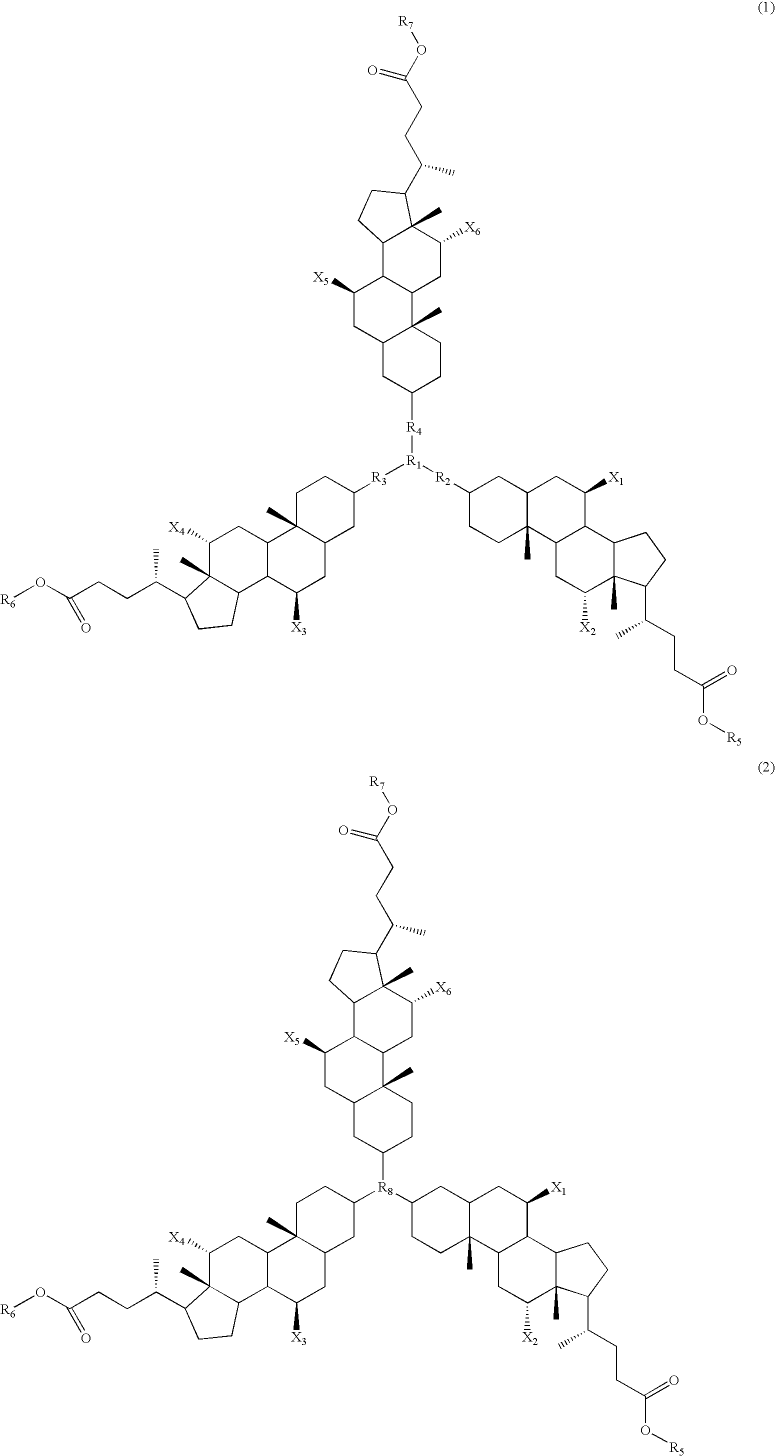

In formulae (1) and (2), R₁ is a triol moiety obtained by removal of three hydrogen atoms from three hydroxyl groups of a triol, R₂, R₃ and R₄ are independently a dicarboxylic acid moiety obtained by removal of two hydrogen atoms from two carboxylic groups of a dicarboxylic acid, R₅, R₆ and R₇ are independently a tert-butyl group, a tetrahydropyranyl group or a 1-ethoxyethyl group, R₈ is a tricarboxylic acid moiety obtained by removal of three hydrogen atoms from three carboxylic groups of a tricarboxylic acid, and X₁ to X₆ are independently a hydrogen atom or a hydroxyl group. Examples of the cross-linking agent may include ethylene oxide, propylene, oxide, ethylene glycol, propanediol, butanediol, dihydroxycyclohexane and/or trihydroxycyclohexane, etc.

According to another aspect of the present invention, there is provided a method of forming a photoresist pattern. In the method of forming the photoresist pattern, a photoresist film is formed on an object by coating the object with a photoresist composition including a cross-linking agent having at least one epoxy group and/or at least two hydroxyl groups, a photosensitive material, an organic solvent and a compound having a chemical structure represented by the formulae (1) or (2) above. The photoresist film is exposed to light, and partially removed from the object to form the photoresist pattern.

### BRIEF DESCRIPTION OF THE DRAWINGS

The above and other features and advantages of the present invention will become readily apparent from the detailed description that follows, with reference to the accompanying drawings, in which:

FIGS. 1 and 2 are conceptional views illustrating a photoresist pattern formed using a polymer-based photoresist composition;

FIGS. 3 to 5 are cross-sectional views for use in explaining a method of forming a photoresist pattern in accordance with an example embodiment of the present invention;

FIGS. 6 and 7 are conceptional views illustrating a photoresist pattern formed using the photoresist composition of an example embodiment of the present invention; and

FIG. 8 is an electron microscopic picture showing a photoresist pattern formed using a photoresist composition prepared in accordance with an example embodiment of the present invention.

### DETAILED DESCRIPTION OF EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When two or more variables of a chemical/polymer structure are said to be “independently” one of two or more possibilities, this means that the two or more variables can all be the same as each other, or all be different from each other, or any combination thereof. For example, if compound/polymer variables Y₁, Y₂ and Y₃ are described as being independently either hydrogen or nitrogen, this means that all of Y₁ through Y₃ can be hydrogen or nitrogen, or any one or more of Y₁ through Y₃ can be hydrogen while the remaining one or more of Y₁ through Y₃ can be nitrogen.

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Photoresist Composition

A photoresist composition of the present invention includes a cross-linking agent, a photosensitive material, an organic solvent and a compound having a chemical structure represented by formulae (1) or (2),

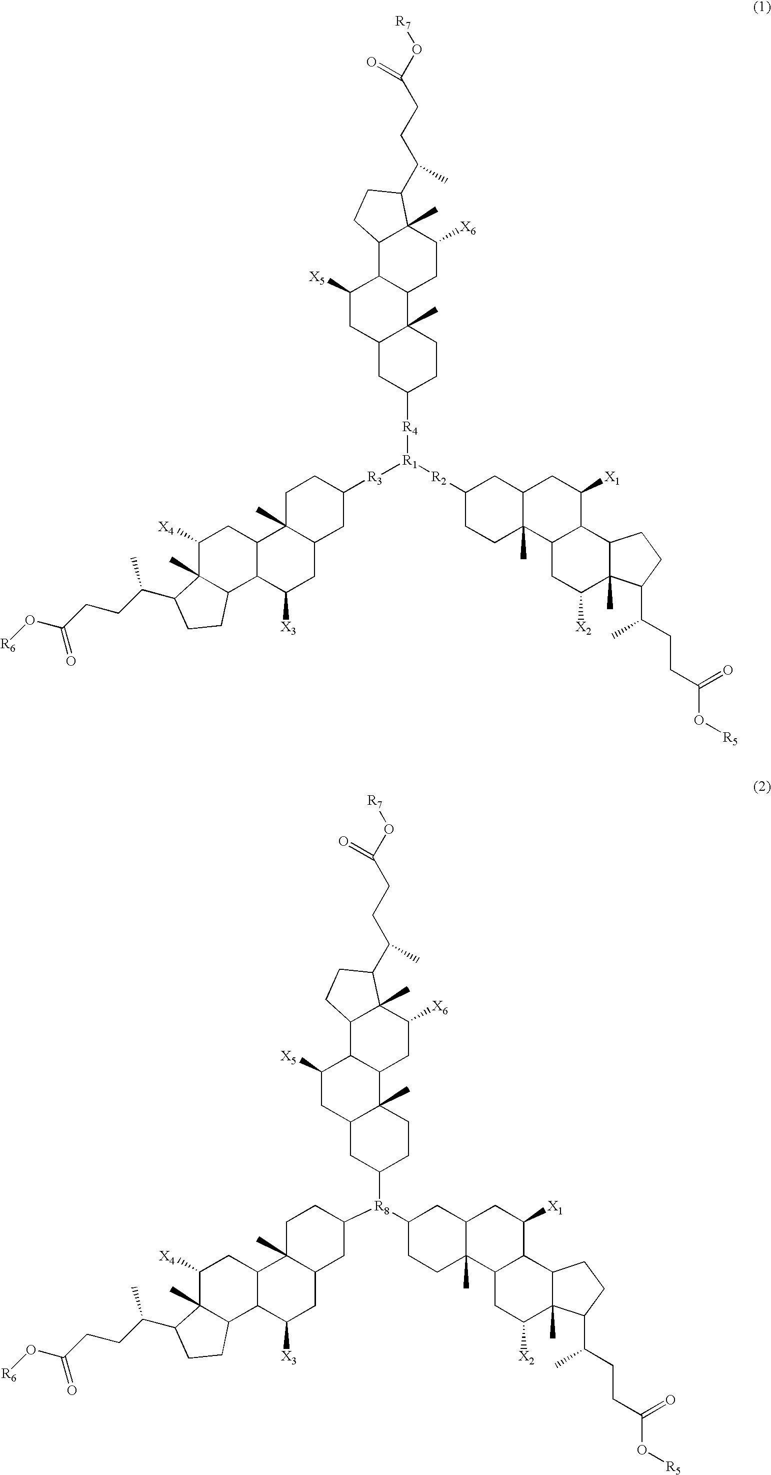

In formulae (1) and (2), R₁ is a triol moiety obtained by removal of three hydrogen atoms from three hydroxyl groups of a triol, R₂, R₃ and R₄ are independently dicarboxylic acid moieties obtained by removal of two hydrogen atoms from two carboxylic groups of a dicarboxylic acid, R₅, R₆ and R₇ are independently a tert-butyl group, a tetrahydropyranyl group or a 1-ethoxyethyl group, R₈ is a tricarboxylic acid moiety obtained by removal of three hydrogen atoms from three carboxylic groups of a tricarboxylic acid, and X₁ to X₆ are independently a hydrogen atom or a hydroxyl group.

Unlike a polymer, the compound represented by the formulae (1) or (2) has a definite molecular structure and a single molecular weight. As a result, when the compound is used for forming a photoresist pattern, solubility of the compound in a developing solution may be relatively constant between molecules to reduce a line width roughness of the photoresist pattern. In addition, the compound has a molecular size substantially smaller than that of a polymer, and thus a photoresist pattern having a molecular level resolution may be formed. Furthermore, the compound has a small rotational radius and a three-dimensional structure, and thus molecular interaction such as entanglement that may be easily generated in a linear polymer may be weak or negligible. As a result, the compound may provide a large solubility difference between a light-exposed portion and an unexposed portion of a photoresist film in a developing process, and thus a photoresist pattern having a high resolution may be formed very clearly and a line width roughness of the photoresist pattern may be greatly reduced.

In an example embodiment of the present invention, R₁ in formula (1) may represent a moiety obtained by removal of three hydrogen atoms from three hydroxyl groups of glycerol or cyclohexanetriol. Each of R₂, R₃ and R₄ in formula (1) may independently represent a moiety obtained by removal of two hydrogen atoms from two carboxylic groups of glutaric acid, succinic acid or 3,3-tetramethyleneglutaric acid. In formula (2), R₈ may represent a moiety obtained by removal of three hydrogen atoms from three carboxylic groups of 1,3,5-cyclohexanetricarboxylic acid.

For example, the compound may have a chemical structure as represented by formulae (3) to (9),

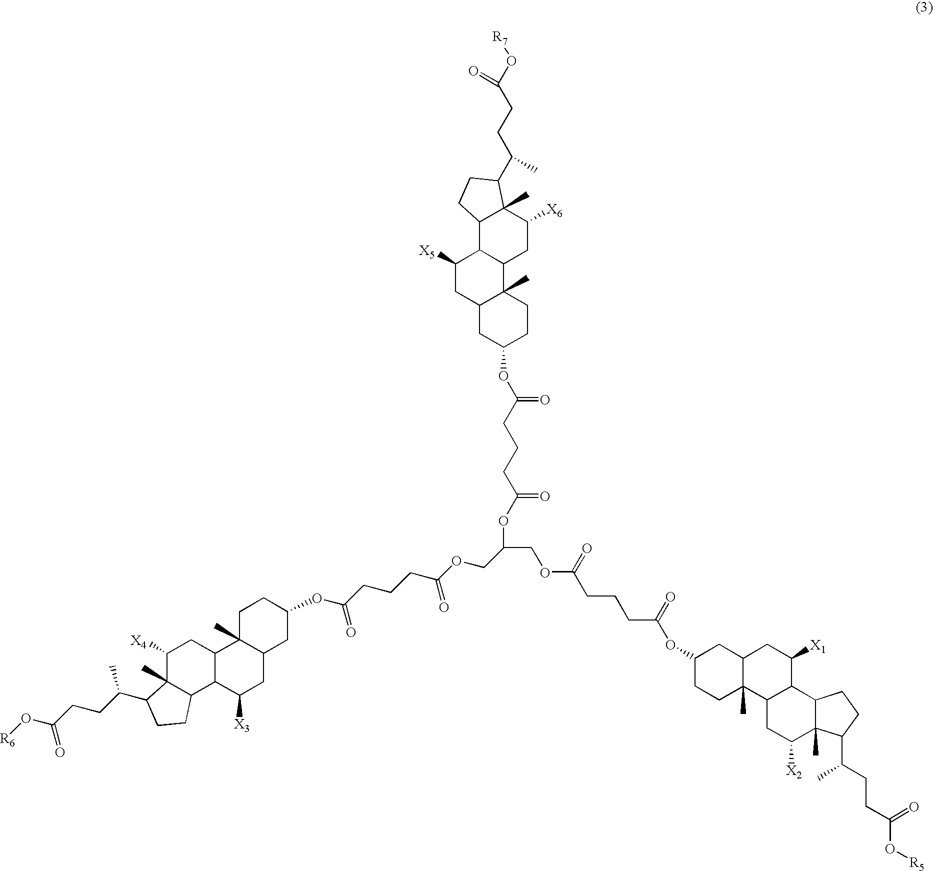

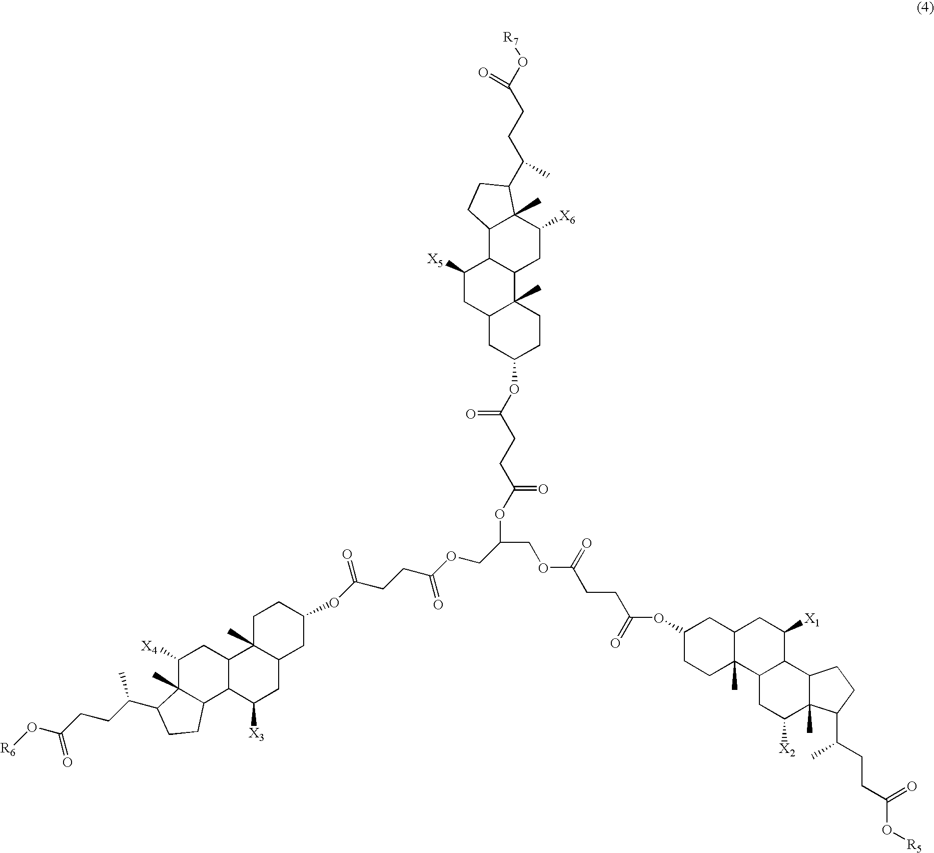

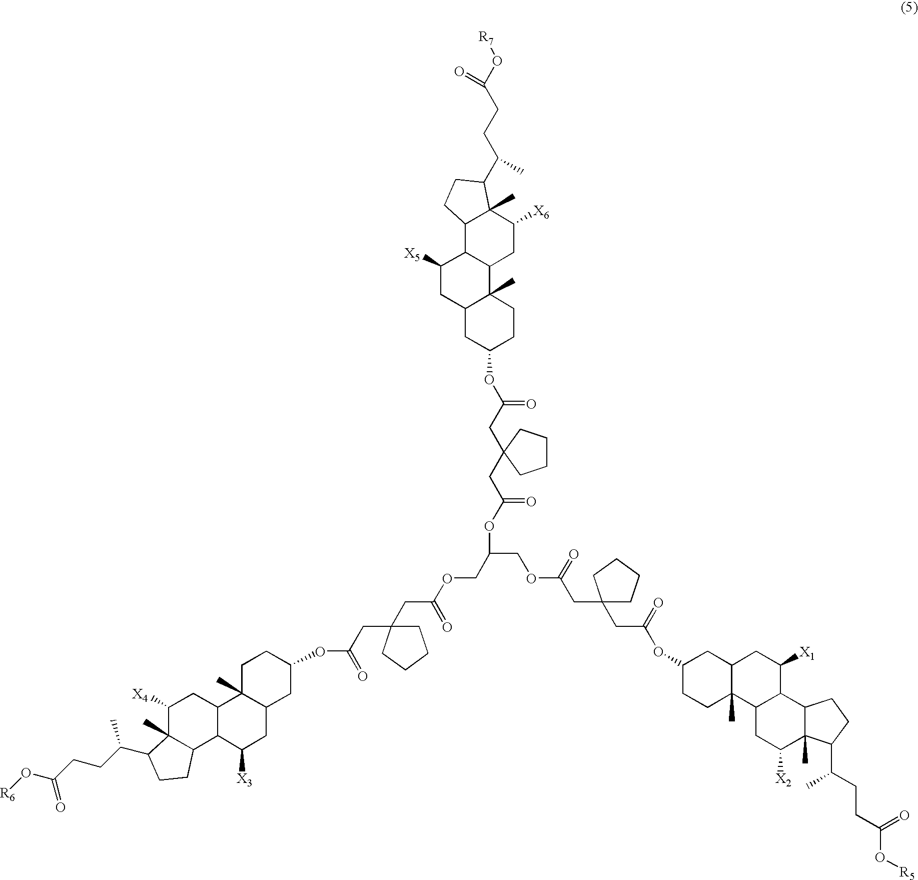

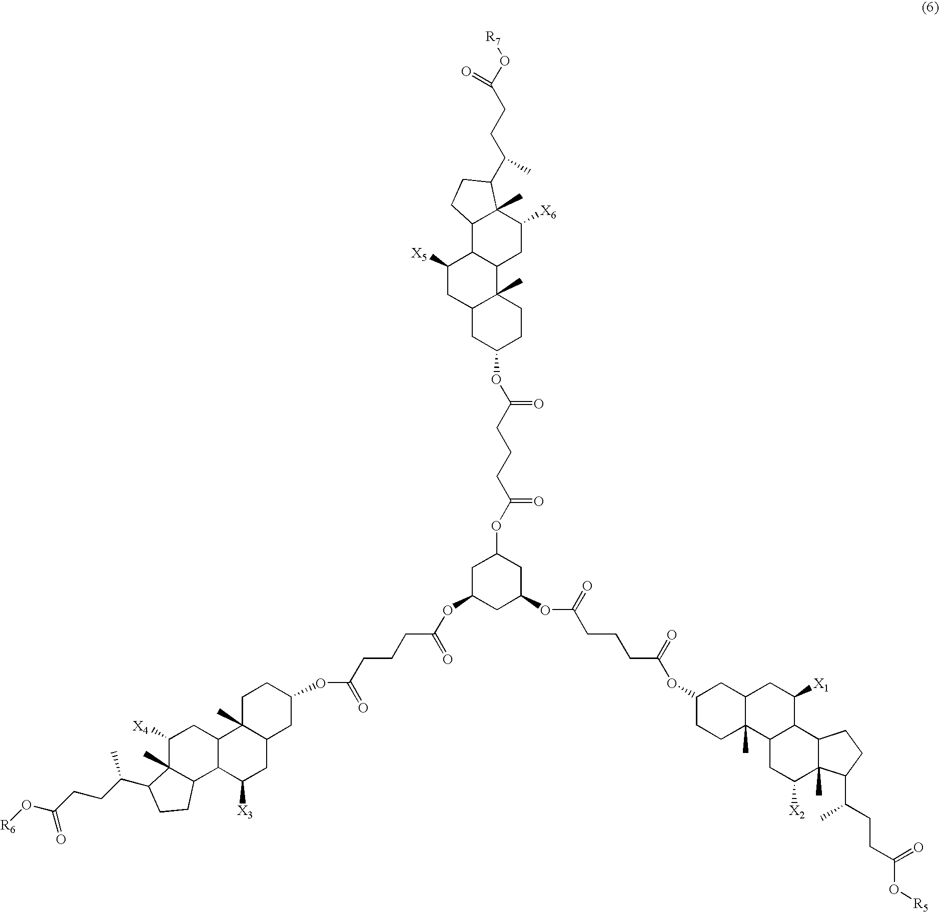

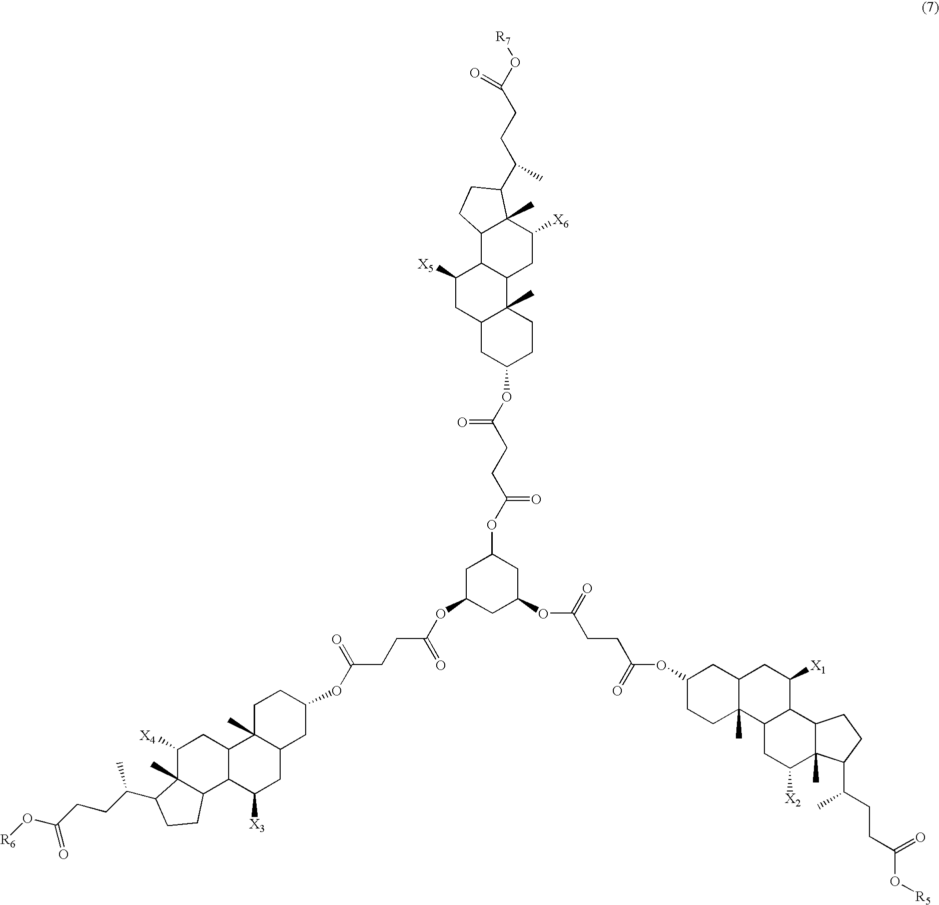

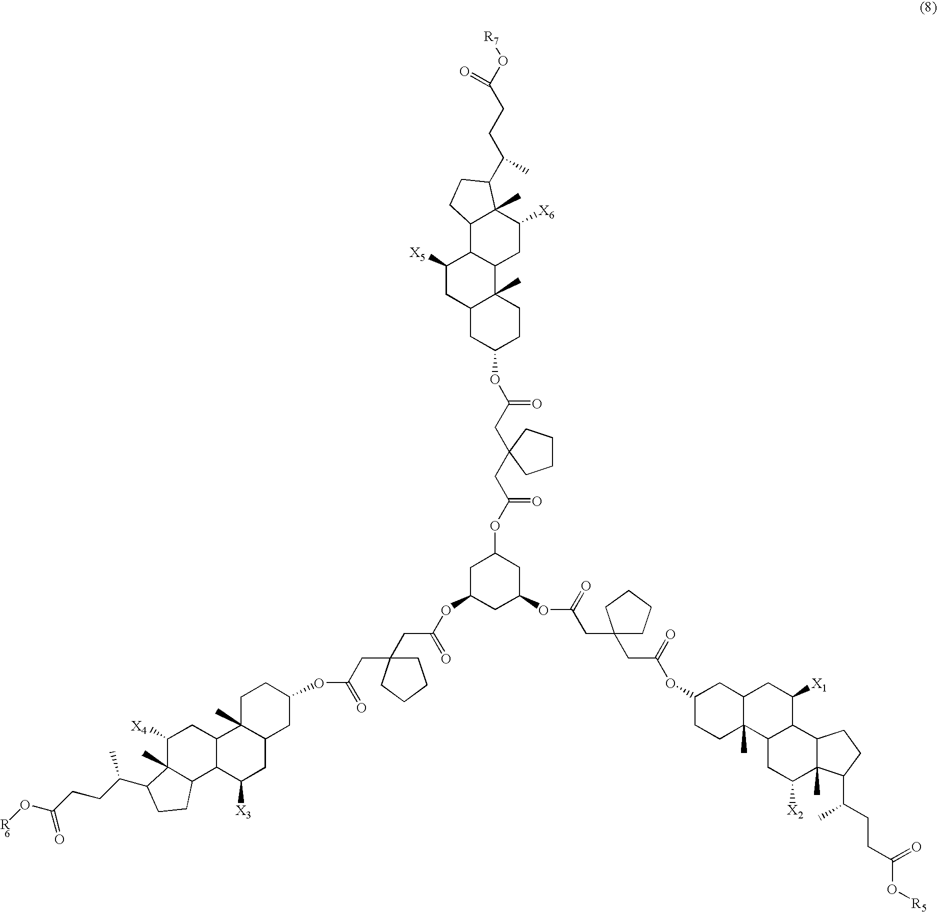

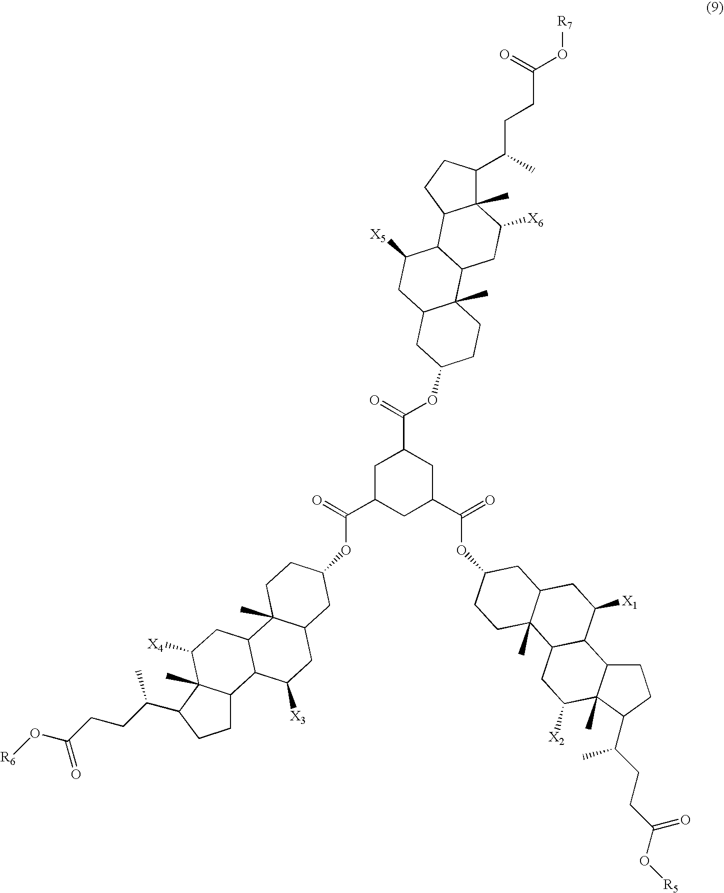

In formulae (1) to (9), R₅, R₆ and R₇ are acid-labile groups that may be reacted with hydrogen ion and then easily detached from the compound. Examples of R₅, R₆ and R₇ may include a tert-butyl group, a tetrahydropyranyl group or a 1-ethoxyethyl group. R₅, R₆ and R₇ may be either the same as one another, or different from one another. In addition, X₁ to X₆ independently represent a hydrogen atom or a hydroxyl group.

The compound represented by the formula (1) may be prepared by synthesizing a core portion including R₁, R₂, R₃ and R₄, and by reacting the core portion with a compound represented by formula (10). In addition, the compound represented by the formula (2) may be prepared by reacting a core portion including R₈ with a compound represented by formula (10).

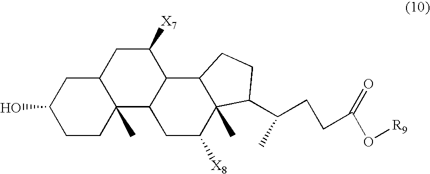

In formula (10), R₉ may represent a tert-butyl group, a tetrahydropyranyl group or a 1-ethoxyethyl group, and X₇ and X₈ may independently represent a hydrogen atom or a hydroxyl group.

To prepare the compound represented by the formula (1), the core portion having R₁, R₂, R₃ and R₄ may be synthesized at first. In the compound represented by the formula (1), the core portion may be synthesized by reacting a triol with a dicarboxylic acid. Examples of the triol may include glycerol or cyclohexanetriol. Examples of the dicarboxylic acid may include glutaric acid, succinic acid or 3,3-tetramethyleneglutaric acid. The core portion synthesized by reacting the triol with the dicarboxylic acid includes three terminal carboxylic groups.

For example, a core portion of the compound represented by the formula (3) may be synthesized by reacting glycerol with glutaric anhydride. A core portion of the compound represented by the formula (4) may be synthesized by reacting glycerol with succinic anhydride. A core portion of the compound represented by the formula (5) may be synthesized by reacting glycerol with 3,3-tetramethyleneglutaric anhydride.

In addition, a core portion of the compound represented by the formula (6) may be synthesized by reacting 1,3,5-trihydroxycyclohexane with glutaric anhydride. A core portion of the compound represented by the formula (7) may be synthesized by reacting 1,3,5-trihydroxycyclohexane with succinic anhydride. A core portion of the compound represented by the formula (8) may be synthesized by reacting 1,3,5-trihydroxycyclohexane with 3,3-tetramethyleneglutaric anhydride.

The core portion of the compound represented by the formula (2) includes a tricarboxylic acid. Non-limiting examples of the tricarboxylic acid may include 1,3,5-cyclohexanetricarboxylic acid, 1,2,4-cyclohexanetricarboxylic acid, 1,3,5-trimethylcyclohexane-1,3,5-tricarboxylic acid, and benzene-1,3,5-tricarboxylic acid. When 1,3,5-cyclohexanetricarboxylic acid is used as the core portion, the compound has a chemical structure represented by the formula (9).

The compound represented by the formula (10) may be synthesized by reacting cholic acid, deoxycholic acid or lithocholic acid with tert-butyl alcohol, tetrahydropyranol or 1-ethoxyethanol. When the compound represented by the formula (10) is synthesized using cholic acid, both X₇ and X₈ represent hydroxyl groups. When the compound represented by the formula (10) is synthesized using deoxycholic acid, X₇ represents a hydrogen atom and X₈ represents a hydroxyl group. When the compound represented by the formula (10) is synthesized using lithocholic acid, both X₇ and X₈ represent hydrogen atoms.

The compound represented by the formulae (1) or (2) may be prepared by an esterification reaction between each of three terminal carboxylic groups in the core portion and a terminal hydroxyl group in the compound represented by the formula (10).

When the photoresist composition includes less than about 8 percent by weight of the compound represented by the formulae (1) or (2), a photoresist pattern of sufficient thickness may not be easily formed. In addition, when the amount of the compound is greater than about 20 percent by weight, the photoresist composition may exhibit excessively high viscosity, and thus a photoresist film having a uniform thickness may not be formed. Thus, the photoresist composition, in an example embodiment of the present invention, may include about 8 to about 20 percent by weight of the compound, and preferably, about 9 to about 15 percent by weight of the compound represented by the formulae (1) or (2).

The photoresist composition of the present invention includes a cross-linking agent. The cross-linking agent includes at least one epoxy group and/or at least two hydroxyl groups.

The cross-linking agent may serve to improve an etching resistance of the photoresist composition. That is, as described above, the photoresist composition of the present invention includes the compound having a nonlinear shape and a low molecular weight as represented by the formulae (1) or (2). Since a chain entanglement of a polymer may not be generated in the compound, the compound may exhibit a weak or negligible molecular interaction. Thus, when a photoresist pattern is formed using the compound, the photoresist pattern may exhibit poor etching resistance. However, the cross-linking agent included in the photoresist composition may combine the compound with adjacent compounds to enhance an etching resistance of the photoresist pattern.

When a portion of a photoresist film is exposed to light, a photosensitive material in the photoresist film may generate an acid. The acid-labile groups of the compound, R₅, R₆ and R₇, may be detached from the compound by the acid, and carboxylic groups may be formed at terminal portions of the compound. The carboxylic groups in the compound may be easily reacted with an epoxy group or a hydroxyl group in the cross-linking agent, and thus the compound may be connected with each other through the cross-linking agent. As a result, the compounds positioned at the light-exposed portion of the photoresist film may be selectively cross-linked together.

When the photoresist composition includes less than about 1 percent by weight of the cross-linking agent, the compounds represented by the formulae (1) or (2) may not be sufficiently cross-linked with each other and thus the photoresist pattern may not exhibit a substantially enhanced etching resistance. In addition, although the extent of cross-linking can be increased by including greater than about 5 percent by weight of the cross-linking agent, the etching resistance may not be enhanced any further, which is considered to be economically unpreferable. Thus, the photoresist composition, in accordance with an example embodiment of the present invention, may include about 1 to about 5 percent by weight of the cross-linking agent, and preferably about 1.5 to about 4 percent by weight of the cross-linking agent.

The cross-linking agent includes at least one epoxy group and/or at least two hydroxyl groups. Examples of the cross-linking agent may include an aliphatic or cycloaliphatic epoxy compound having substantially less than or equal to about 20 carbon atoms and at least one epoxy group, or an aliphatic, cycloaliphatic or aromatic polyol compound having substantially less than or equal to about 20 carbon atoms. These can be used individually or in a combination of two or more thereof.

Particularly, examples of the cross-linking agent may include compounds having chemical structures represented by formulae 11 to 14,

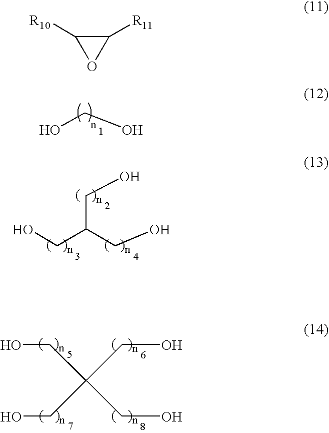

In formula (11), R₁₀ and R₁₁ independently represent hydrogen atom or an alkyl or cycloalkyl group having substantially less than or equal to about 20 carbon atoms, and in formulae (12) to (14), n₁ represents an integer of 1 to 20 and each of n₂ to n₈ independently represents an integer of 0 to 20.

Non-limiting examples of the cross-linking agent having at least one epoxy group may include ethylene oxide, propylene oxide, 1,2-epoxybutane, 2,3-epoxybutane, 1,2-epoxypentane, 2,3-epoxypentane, 1,2-epoxyhexane, 2,3-epoxyhexane, 1,2-epoxyheptane, 1,2-epoxyoctane, 1,2-epoxynonane, 1,2-epoxydecane, 1,2-epoxydodecane, 1,2-epoxyhexadecane, 9,10-epoxyoctadecane, and 1,2-epoxycyclohexane. These can be used individually or in a combination of two or more thereof.

Non-limiting examples of the cross-linking agent having at least two hydroxyl groups may include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,16-hexadecanediol, 1,18-octadecanediol, glycerol, 2-hydroxymethyl-1,3-propanediol, 1,2,4-butanetriol, 1,3,5-pentanetriol, 1,2,6-hexanetriol, 1,2,8-octanetriol, 1,2,3,4-butanetetrol, 2,2-bis(hydroxymethyl)-1,3-propanediol, 2,2,4,4-pentanetetrol, 1,2,7,8-octanetetrol, 1,4-cyclohexanediol, 1,3,5-cyclohexanetriol, 1,2,4,5-tetrahydoxycyclohexane, hexahydroxycyclohexane, 1,4-benzenediol, 1,3,5-trihydroxybenzene, 1,2,4,5-tetrahydroxybenzene, and hexahydroxybenzene. These can be used individually or in a combination of two or more thereof.

The photoresist composition of the present invention includes a photosensitive material. The photosensitive material may serve as a photoacid generator that may be reacted with light to generate an acid, i.e. hydrogen ions (H⁺). The acid generated in the photosensitive material may detach terminal groups represented by R₅, R⁶, and R₇ from the compound represented by the formulae (1) or (2). The terminal groups represented by R₅, R₆ and R₇ may be an acid-labile group that may be reacted with the acid to be easily separated from the compound. As a result, solubility of the compound may vary in a developing solution.

When the photoresist composition includes less than about 0.1 percent by weight of the photosensitive material, the amount of the acid generated in the photosensitive material may be so small that the acid-labile groups may not be sufficiently detached from the compound represented by the formulae (1) or (2) at an light-exposed portion of a photoresist film, and therefore a photoresist pattern may not be formed clearly. In addition, when the amount of the photosensitive material is greater than about 0.5 percent by weight, the amount of the acid generated in the photosensitive material may be so excessive that a photoresist pattern having a round edge may be formed, and the photoresist film may be damaged in a developing process. Thus, the photoresist composition, in accordance with an example embodiment of the present invention, may include about 0.1 to about 0.5 percent by weight of the photosensitive material, and preferably about 0.15 to about 0.4 percent by weight of the photosensitive material.

Non-limiting examples of the photosensitive material that may be used in the photoresist composition of the present invention may include a sulfonium salt, a triarylsulfonium salt, an iodonium salt, a diaryliodonium salt, nitrobenzyl ester, disulfone, diazo-disulfone, sulfonate, trichloromethyltriazine, and N-hydroxysuccinimide triflate. These can be used individually or in a combination of two or more thereof.

In particular, non-limiting examples of the photosensitive material may include triphenylsulfonium triflate, triphenylsulfonium antimony salt, diphenyliodonium triflate, diphenyliodonium antimony salt, methoxydiphenyliodonium triflate, di-tert-butyidiphenyliodonium triflate, 2,6-dinitrobenzyl sulfonate, pyrogallol tris(alkylsulfonate), norbornene-dicarboxyimide triflate, triphenylsulfonium nonaflate, diphenyliodonium nonaflate, methoxydiphenyliodonium nonaflate, di-tert-butyldiphenyliodonium nonaflate, N-hydroxysuccinimide nonaflate, norbornene dicarboxyimide nonaflate, triphenylsulfonium perfluorooctanesulfonate, diphenyliodonium perfluorooctanesulfonate, methoxyphenyliodonium perfluorooctanesulfonate, di-tert-butyidiphenyliodonium triflate, N-hydroxysuccinimide perfluorooctanesulfonate, and norbornene dicarboxyimide perfluorooctanesulfonate. These can be used individually or in a combination of two or more thereof.

Non-limiting examples of the organic solvent that may be used in the photoresist composition of the present invention may include ethylene glycol monomethyl ether, ethylene glycol monoethyl ether, propylene glycol methyl ether, methyl cellosolve acetate, ethyl cellosolve acetate, diethylene glycol monomethyl ether, diethylene glycol monoethyl ether, propylene glycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone, and 4-heptanone. These can be used individually or in a combination of two or more thereof.

In an example embodiment of the present invention, the photoresist composition may further include an organic base. The organic base may control a diffusion distance of an acid generated from the photosensitive material. Thus, the organic base may serve to form a clear photoresist pattern and to reduce a line width roughness.

When the photoresist composition, in accordance with an example embodiment of the present invention, includes less than about 0.1 percent by weight of the organic base, the clearness and/or the line width roughness of the photoresist pattern may not be substantially improved, which is considered not to be preferable. In addition, when the amount of the organic base is greater than about 5 percent by weight, the line width roughness of the photoresist pattern may not be reduced any further, which is considered not to be economically preferable. Thus, the photoresist composition, in accordance with an example embodiment of the present invention, may include about 0.1 to about 5 percent by weight of the organic base, and preferably about 1 to about 4 percent by weight of the organic base.

Non-limiting examples of the organic base that may be used in the photoresist composition, according to an example embodiment of the present invention, may include triethylamine, triisobutylamne, triisooctylamine, triisodecylamine, diethanolamine, and triethanolamine. These can be used individually or in a combination of two or more thereof.

According to the present invention, the photoresist composition includes the compound having a nonlinear shape and a low-molecular weight instead of a polymer. As such, the photoresist composition may be used for forming a fine pattern having a molecular-level resolution. In addition, the photoresist composition may have a constant solubility between molecules in a developing solution and a negligible chain entanglement. As such, a line width roughness of a photoresist pattern may be substantially reduced. Furthermore, the photoresist composition including the cross-linking agent may enhance an etching resistance of the photoresist pattern.

Method of Forming a Photoresist Pattern

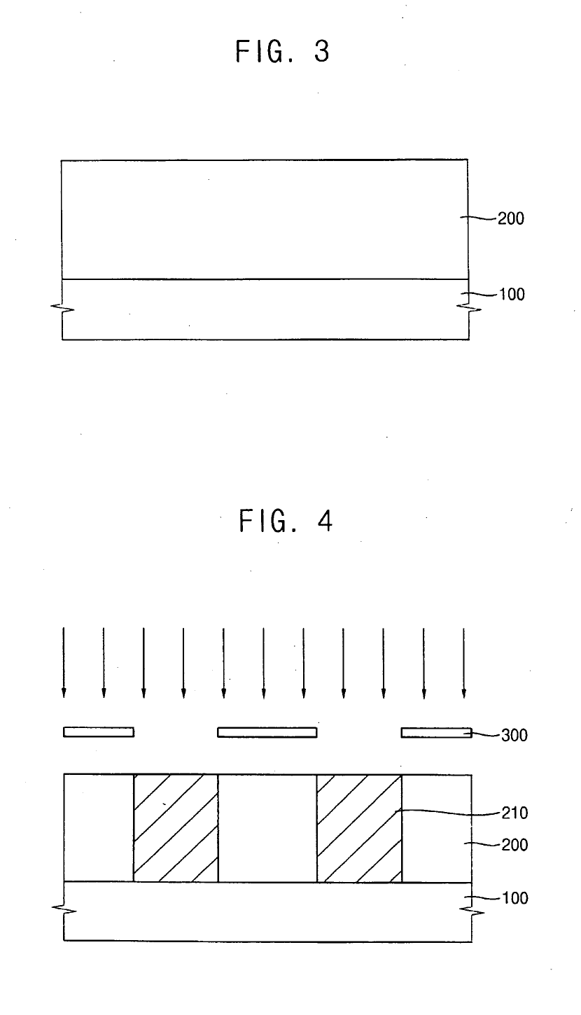

FIGS. 3 to 5 are cross-sectional views for use in explaining a method of forming a photoresist pattern in accordance with an example embodiment of the present invention.

Referring to FIG. 3, an object is prepared. Examples of the object may include a substrate such as a silicon wafer or a silicon on insulator (SOI) substrate, or a substrate on which a layer, a film or a structure is formed. For example, the object may be a substrate on which a silicon nitride layer is formed. Hereinafer, a case in which the object is a substrate 100 will be described. A surface treatment process may be selectively performed onto the substrate 100 to remove moisture and/or contaminants from the substrate 100.

A photoresist film 200 is formed on the substrate 100 by coating the substrate 100 with a photoresist composition including a cross-linking agent, a photosensitive material, an organic solvent and a compound having a chemical structure represented by formulae (1) or (2),

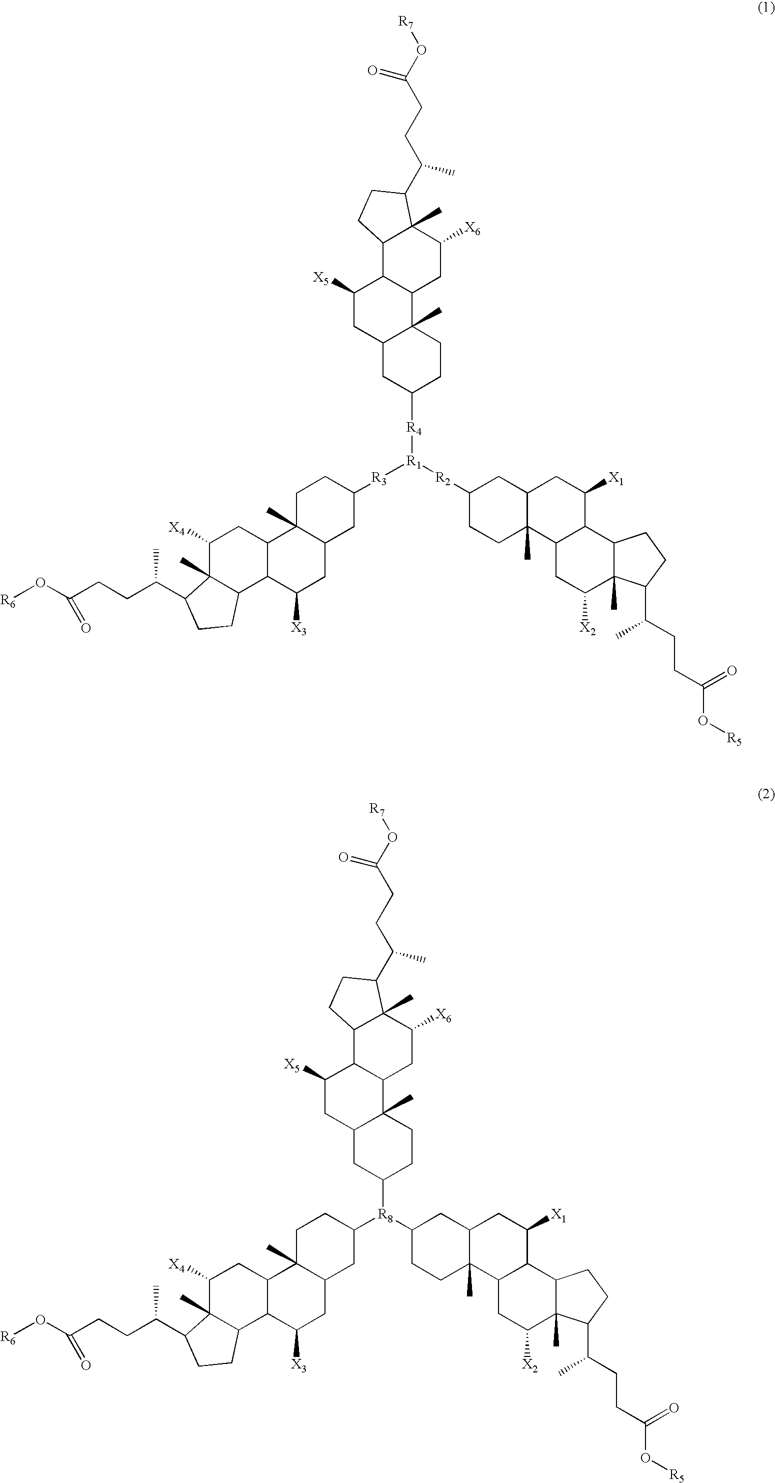

In formulae (1) and (2), R₁ is a triol moiety obtained by removal of three hydrogen atoms from three hydroxyl groups of a triol, each of R₂, R₃ and R₄ are independently a dicarboxylic acid moiety obtained by removal of two hydrogen atoms from two carboxylic groups of a dicarboxylic acid, R₅, R₆ and R₇ are independently a tert-butyl group, a tetrahydropyranyl group or a 1-ethoxyethyl group, R₈ is a tricarboxylic acid moiety obtained by removal of three hydrogen atoms from three carboxylic groups of a tricarboxylic acid, and X₁ to X₆ are independently a hydrogen atom or a hydroxyl group. The photoresist composition is previously described, so any further explanations in this regard will be omitted herein for brevity.

In an example embodiment of the present invention, a first baking process may be performed onto the substrate 100 including the photoresist film 200 thereon. The first baking process may be carried out at temperature of about 90° C. to about 130° C. The first baking process may enhance adhesion characteristics between the substrate 100 and the photoresist film 200.

Referring to FIG. 4, the substrate 100 having the photoresist film 200 is exposed to light. In particular, a mask 300 on which a predetermined pattern is formed is positioned on a mask stage of an exposure apparatus. The mask 300 is arranged over the substrate 100 having the photoresist film 200 thereon in an alignment process. An illumination light (represented by the arrows of FIG. 4) is irradiated onto the mask 300 for a predetermined time, and thus an exposed portion 210 of the photoresist film 200 may be selectively reacted with light through the mask 300. Non-limiting examples of the light may include a mercury-xenon (Hg—Xe) light, a G-line ray, an I-line ray, a krypton fluoride laser, an argon fluoride laser, an electron beam, and an X-ray. These can be used individually or in a combination thereof.

In an example embodiment of the present invention, a second baking process may be performed onto the substrate 100 after the exposure process. The second baking process may be performed at a temperature of about 90° C. to about 160° C. In the exposure process and the second baking process, the exposed portion 210 of the photoresist film 200 may have solubility which is substantially different from that of an unexposed portion of the photoresist film 200.

In particular, an acid (H⁺) may be generated from the photosensitive material at the exposed portion 210 of the photoresist film 200. The acid-labile groups R₅, R₆ and R₇ in the formulae (1) or (2) may be detached from the compound by the acid, and carboxylic groups may be formed at terminal portions of the compound. The carboxylic groups in the compound may be easily reacted with an epoxy group or a hydroxyl group in the cross-linking agent, and thus the compounds may be connected with each other through the cross-linking agent. As a result, the compounds positioned at the exposed 210 portion of the photoresist film 200 may be selectively cross-linked together.

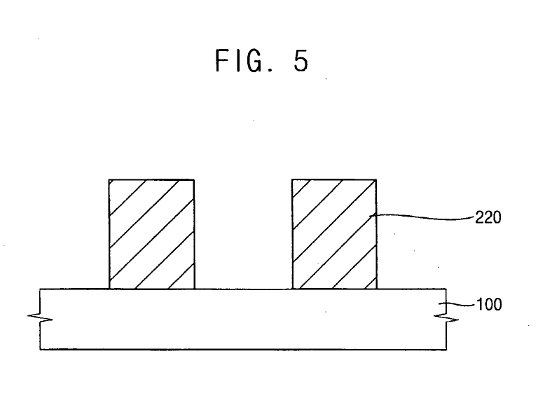

Referring to FIG. 5, the unexposed portion of the photoresist film 200 is removed to form a photoresist pattern 220 on the substrate 100. For example, the photoresist film 200 may be developed using a developing solution having cyclohexanone.

The substrate 100 including the photoresist pattern 220 thereon may be cleaned, and then other ordinary processes may be performed. A lower layer formed under the photoresist pattern 220 may be etched using the photoresist pattern as a mask to form various structures of a semiconductor device on the substrate 100.

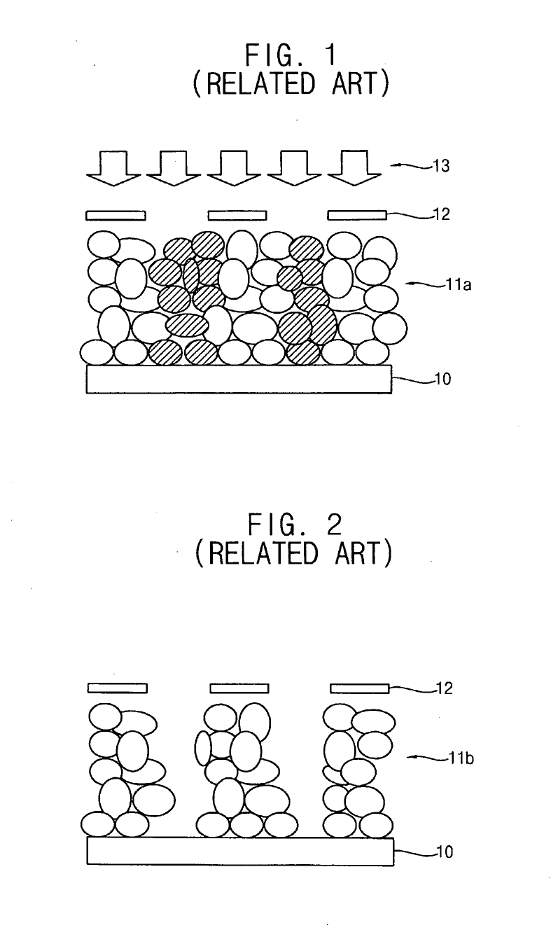

As previously described with reference to FIGS. 1 and 2, a polymer-based photoresist composition may not result in the formation of a fine pattern having a molecular-level resolution due to a large molecular size of the polymer contained in the composition. Further, a photoresist pattern of a polymer-based photoresist composition may exhibit a high line width roughness and a nonuniform thickness. In addition, solubility in a developing solution may vary depending on a molecular size of the polymer, and a chain entanglement may be generated. Thus, the line width roughness of the photoresist pattern may further increase. In contrast, the photoresist composition of the present invention includes a low molecular weight compound instead of a polymer, and as a result, a size of a building block forming the photoresist pattern may be relatively small.

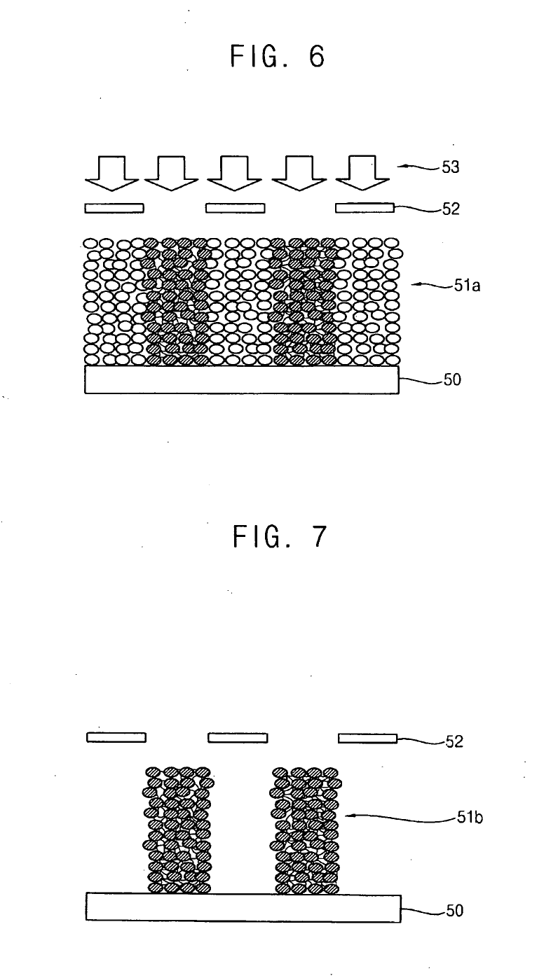

FIGS. 6 and 7 are conceptional views illustrating a photoresist pattern formed using the photoresist composition of the present invention. In these figures, reference number 50 denotes an object to be patterned, and reference number 52 denotes a mask. Further, in FIG. 6, reference number 53 denotes light energy, and reference number 51A denotes a photoresist layer formed of building blocks which are substantially smaller than polymeric building blocks (contrast FIG. 1), where the light exposed building blocks are cross-hatched in the drawing. In FIG. 7, reference number 51B denotes the photoresist layer after a development process in which the light exposed building blocks have been removed.

Referring to FIGS. 6 and 7, the photoresist composition of the present invention includes a compound having a nonlinear shape and a low molecular weight, and has a building block of a photoresist pattern which is substantially smaller than that of a polymer-based photoresist composition. As such, the photoresist composition may be used for forming a fine pattern having a molecular-level resolution. In addition, the photoresist composition may exhibit a constant solubility between molecules in a developing solution due to a single molecular weight of the compound, and the photoresist composition may exhibit a negligible chain entanglement so that a line width roughness of the photoresist pattern may be substantially reduced. As a result, the photoresist composition of the present invention including the low molecular weight compound may be used to form a fine pattern having a molecular-level resolution and a reduced line width roughness. Furthermore, the cross-linking agent included in the photoresist composition of the present invention may combine the compound with adjacent compounds. Thus, the photoresist composition including the cross-linking agent may greatly enhance an etching resistance of the photoresist pattern.

The photoresist composition of the present invention will now be further described through Synthesis Examples and Examples.

Synthesis of Compounds

### SYNTHESIS EXAMPLE 1

About 4.8 g of 1,3,5-cyclohexanetricarboxylic acid was added into an excessive amount of thionyl chloride and dissolved by a stirring process at a room temperature for about two hours. The reactant was refluxed at a temperature of about 70° C. for about two hours. After the completion of the reaction, a remaining thionyl chloride was evaporated and the resulting material was cleaned three times using dried toluene to obtain 1,3,5-cyclohexanetricarbonyl chloride. About 2.2 g of triethylamine and about 10.0 g of tert-butyl cholate were dissolved in about 200 mL of anhydrous diethyl ether under a nitrogen atmosphere to obtain a solution. About 15.5 g of an anhydrous diethyl ether solution, in which the obtained 1,3,5-cyclohexanetricarbonyl chloride was dissolved, was added dropwise into the solution. After performing the reaction at a room temperature for about 6 hours, triethylamine salt was removed using a filter and a final product was separated using a column chromatography.

A structure of the final product was confirmed using a ¹H-nuclear magnetic resonance (¹H-NMR) spectrum and a Fourier transform infrared (FT-IR) spectrum. The ¹H-NMR spectrum was measured on the final product dissolved in chloroform-d (CDCl₃). The ¹H-NMR spectrum showed chemical shifts (δ) of the final product at 0.65 ppm (3H, s, 18 methyl), 0.88 ppm (3H, s, 19 methyl), 0.96 ppm (3H, d, J=6 Hz, 21 methyl), 1.01-2.02 ppm (26H, m), 1.41 ppm (9H, s, t-butyl), 3.86 ppm (1H, m) and 3.96 ppm (1H, m). The FT-IR spectrum showed peaks at 2940 cm⁻¹ (clcyloaliphatic CH) and at 1738 cm⁻¹ (ester C═O). From the analyses of the ¹H-NMR spectrum and the FT-IR spectrum, it was confirmed that the final product was a compound having a chemical structure represented by formula (15).

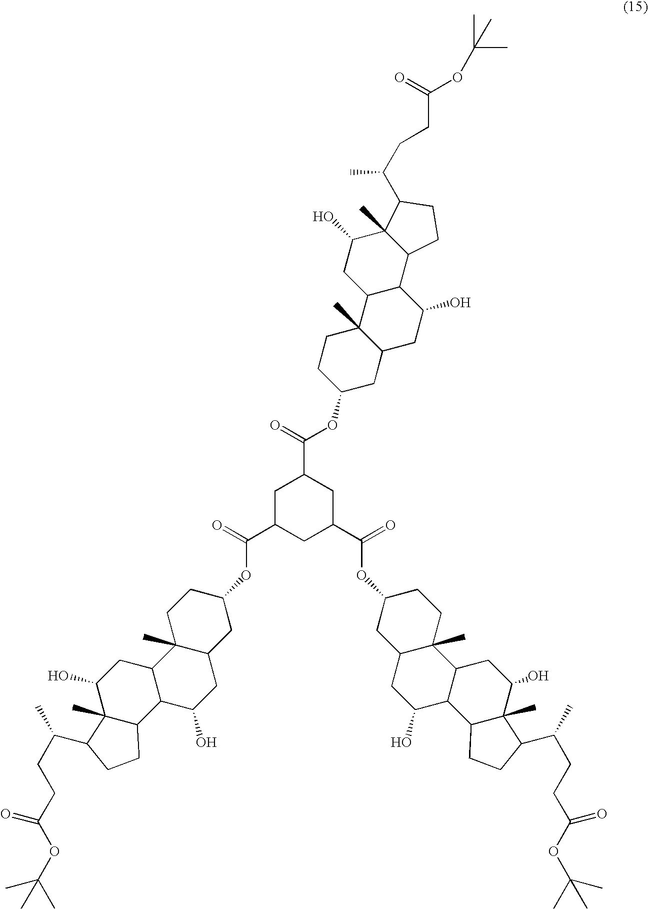

### SYNTHESIS EXAMPLE 2

About 5.0 g of glycerol, about 18.5 g of glutaric anhydride and a catalytic amount of pyridine were dissolved in about 150 mL of 1,4-dioxane, and refluxed for about 24 hours. After the completion of the reaction, 1,4-dioxane and pyridine were evaporated to obtain a first product. The obtained first product was dissolved in an excessive amount of thionyl chloride, and stirred at a room temperature for about two hours. After the completion of the reaction, a remaining thionyl chloride was evaporated to obtain a second product. About 2.2 g of triethylamine and about 10.0 g of tert-butyl cholate were dissolved in about 200 mL of anhydrous diethyl ether under a nitrogen atmosphere to obtain a solution. About 15 g of an anhydrous diethyl ether solution, in which the obtained second product was dissolved, was added dropwise into the solution. After the completion of the reaction, triethylamine salt was removed using a filter, and a final product was separated using a column chromatography.

A structure of the final product was confirmed using a ¹H-nuclear magnetic resonance (¹H-NMR) spectrum and a Fourier transform infrared (FT-IR) spectrum. The ¹H-NMR spectrum was measured on the final product dissolved in chloroform-d (CDCl₃). The ¹H-NMR spectrum showed chemical shifts (δ) of the final product at 0.65 ppm (3H, s, 18 methyl), 0.88 ppm (3H, s, 19 methyl), 0.96 ppm(3H, d, J=6 Hz, 21 methyl), 1.01-2.02 ppm (26H, m), 1.41 ppm (9H, s, t-butyl), 3.86 ppm (1 H, m) and 3.96 ppm (1H, m). The FT-IR spectrum showed peaks at 3444 cm⁻¹ (OH), 2938 cm⁻¹ (aliphatic and cycloaliphatic CH) and at 1730 cm⁻¹ (ester C═O). From the analyses of the ¹H-NMR spectrum and the FT-IR spectrum, it was confirmed that the final product was a compound having a chemical structure represented by formula (16). 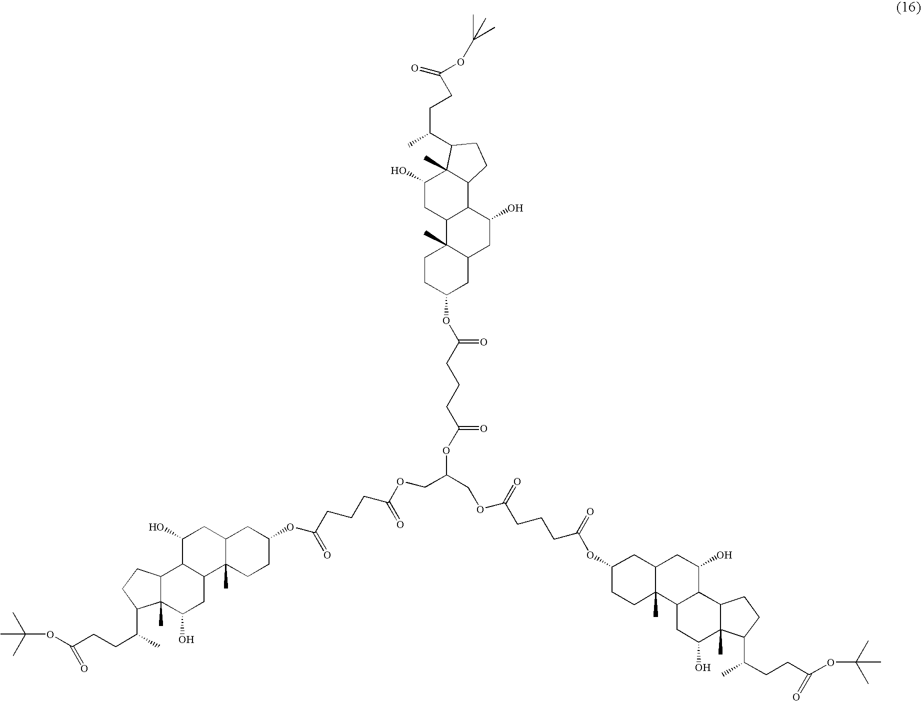
Preparation of Photoresist Compositions

### EXAMPLE 1

About 11 percent by weight of the compound represented by the formula (15) that was synthesized in Synthesis Example 1, about 2.2 percent by weight of 2,2-bis(hydroxymethyl)-1,3-propanediol, about 0.2 percent by weight of triphenylsulfonium triflate, and about 86.6 percent by weight of propylene glycol methyl ether acetate were mixed together to prepare a photoresist composition.

### EXAMPLE 2

About 11.1 percent by weight of the compound represented by the formula (16) that was synthesized in Synthesis Example 2, about 2.2 percent by weight of 2,2-bis(hydroxymethyl)-1,3-propanediol, about 0.2 percent by weight of triphenylsulfonium triflate, and about 86.5 percent by weight of propylene glycol methyl ether acetate were mixed together to prepare a photoresist composition.

Evaluation of Photoresist Pattern Formation

The successful formation of a photoresist pattern was evaluated using the photoresist composition prepared in Example 1.

A photoresist film was formed on a silicon wafer by spin coating the photoresist composition prepared in Example 1. The silicon wafer on which the photoresist film was formed, was first baked at a temperature of about 110° C. for about 60 seconds. The photoresist film was exposed to light through a mask having a predetermined pattern. The exposure process was performed using a mercury-xenon (Hg—Xe) lamp, and about 12 mJ/cm² of the light was irradiated. The exposed photoresist film was second baked at a temperature of about 150° C. for about 60 seconds. The photoresist film was then developed by making contact with cyclohexane for about 60 seconds. After the developing process, the silicon wafer was cleaned to remove the remaining developing solution from the silicon wafer, and then dried to complete a photoresist pattern. The formation of the photoresist pattern was confirmed using an electron microscope.

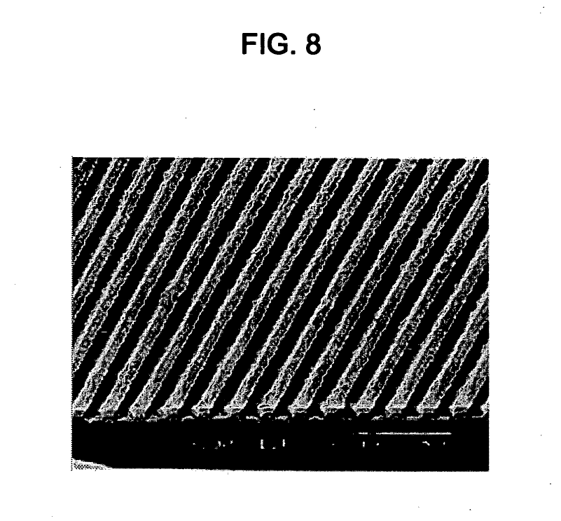

FIG. 8 is an electron microscopic image showing the photoresist pattern formed using the photoresist composition prepared in Example 1.

As shown in FIG. 8, it was confirmed that the photoresist pattern of a predetermined thickness was clearly formed on the silicon wafer. An exposed portion of the photoresist film removed by the developing solution and an unexposed portion of the photoresist film that remained as the photoresist pattern on the silicon wafer were clearly distinguished from each other. Thus, it may be noted that although the photoresist composition of the present invention includes a compound having a nonlinear shape and a low molecular weight instead of a polymer, the photoresist composition may be adapted for forming a photoresist pattern. Although not shown, it was also confirmed that the photoresist composition prepared in Example 2 may clearly form a photoresist pattern like the photoresist composition prepared in Example 1.

According to the present invention, a photoresist composition includes the compound having a nonlinear shape and a low molecular weight, and accordingly, the photoresist composition may be used to form a fine pattern having a molecular-level resolution. In addition, the photoresist composition includes the compound having a single molecular weight so that the photoresist composition may exhibit a constant solubility between molecules in a developing solution, and a chain entanglement between molecules of the compound may be negligible. Thus, a line width roughness of a photoresist pattern may be greatly reduced. Furthermore, the cross-linking agent included in the photoresist composition of the present invention may combine the compound with adjacent compounds. Thus, the photoresist composition including the cross-linking agent may substantially enhance an etching resistance of the photoresist pattern.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A photoresist composition comprising a cross-linking agent including at least one epoxy group and/or at least two hydroxyl groups, a photosensitive material, an organic solvent, and a compound having a chemical structure represented by formulae (1) or (2), 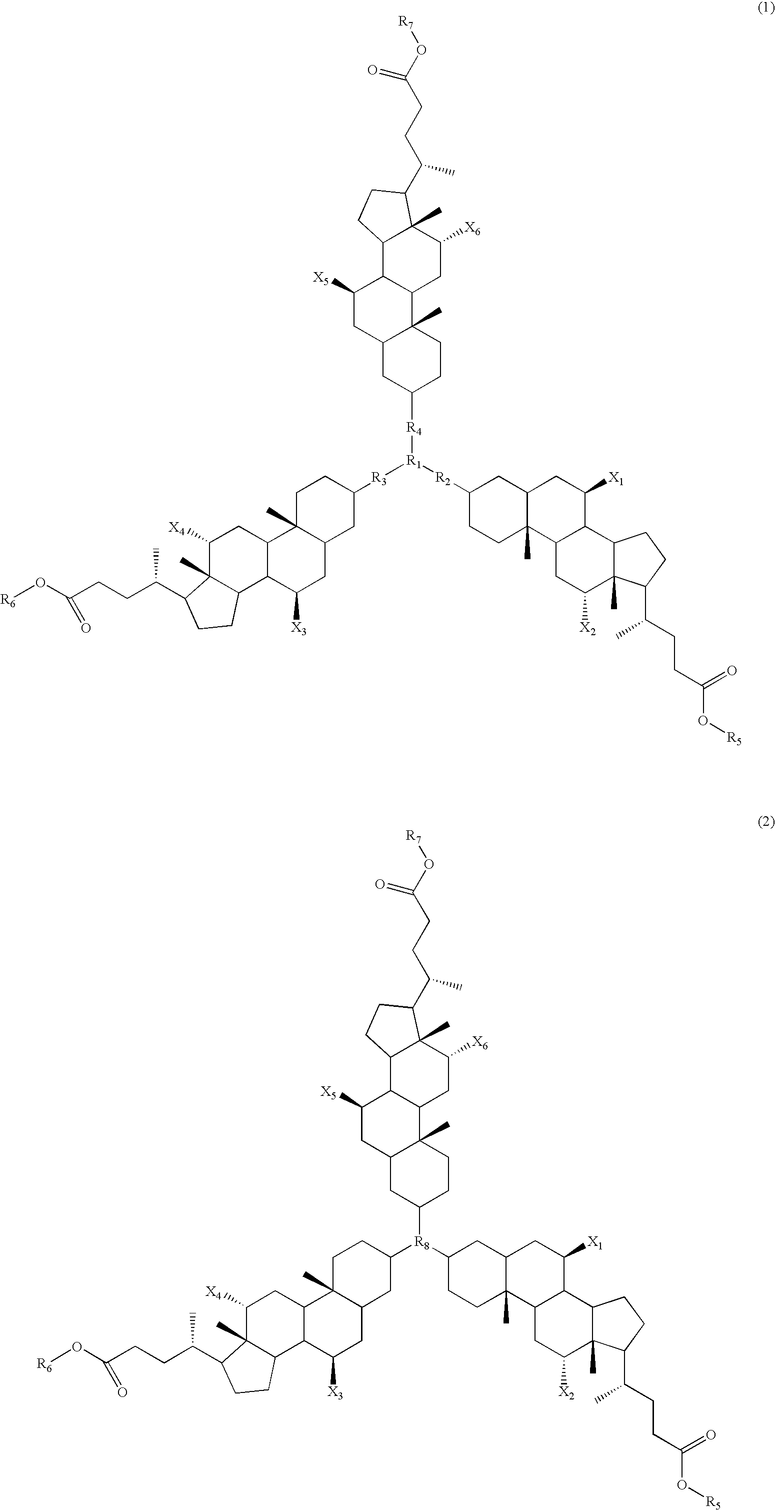
wherein in formulae (1) and (2), R₁ is a triol moiety obtained by removal of three hydrogen atoms from three hydroxyl groups of a triol, R₂, R₃ and R₄ are independently dicarboxylic acid moieties obtained by removal of two hydrogen atoms from two carboxylic groups of a dicarboxylic acid, R₅, R₆ and R₇ are independently a tert-butyl group, a tetrahydropyranyl group or a 1-ethoxyethyl group, R₈ is a tricarboxylic acid moiety obtained by removal of three hydrogen atoms from three carboxylic groups of a tricarboxylic acid, and X₁ to X₆ are independently a hydrogen atom or a hydroxyl group.

2. The photoresist composition of claim 1, wherein the photoresist composition comprises about 8 to about 20 percent by weight of the compound having the chemical structure represented by formulae (1) or (2), about 1 to about 5 percent by weight of the cross-linking agent, and about 0.1 to about 0.5 percent by weight of the photosensitive material, based on a total weight of the photoresist composition.

3. The photoresist composition of claim 1, wherein in formula (1), R₁ represents a moiety obtained by removal of three hydrogen atoms from three hydroxyl groups of glycerol or cyclohexanetriol.

4. The photoresist composition of claim 1, wherein in formula (1), each of R₂, R₃ and R₄ independently represents a moiety obtained by removal of two hydrogen atoms from two carboxylic groups of glutaric acid, succinic acid or 3,3-tetramethyleneglutaric acid.

5. The photoresist composition of claim 1, wherein in formula (2), R₈ represents a moiety obtained by removal of three hydrogen atoms from three carboxylic groups of 1,3,5-cyclohexanetricarboxylic acid.

6. The photoresist composition of claim 1, wherein the compound has a chemical structure represented by one of formulae (3) to (9), 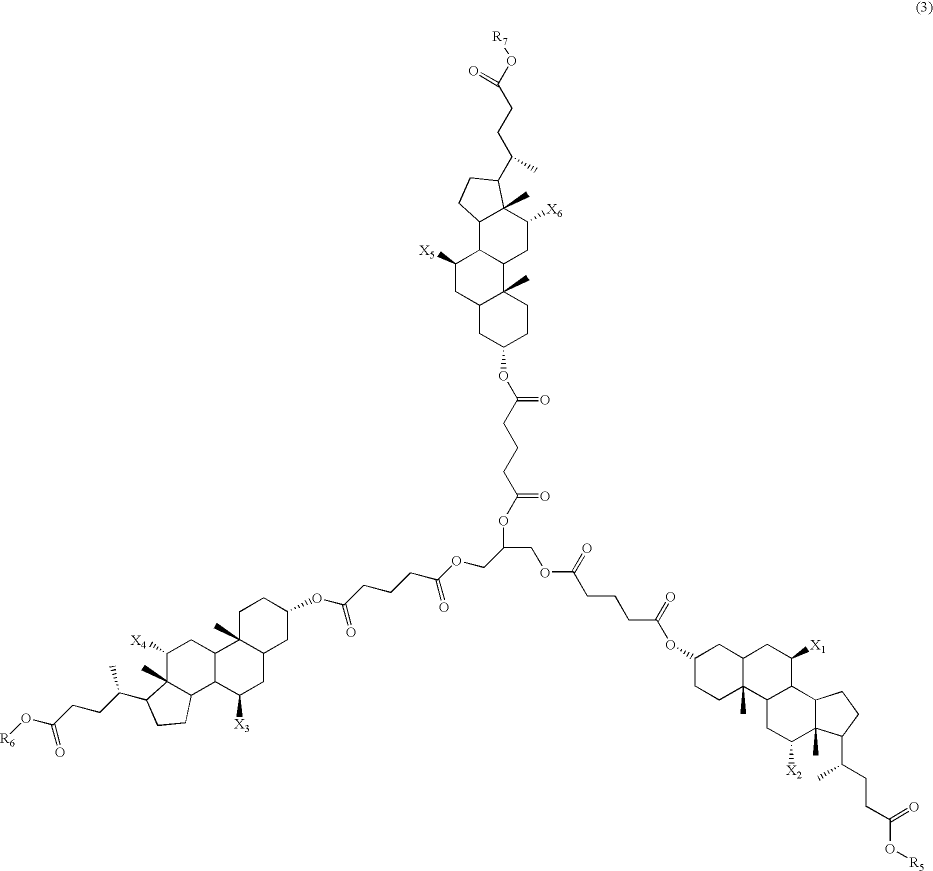 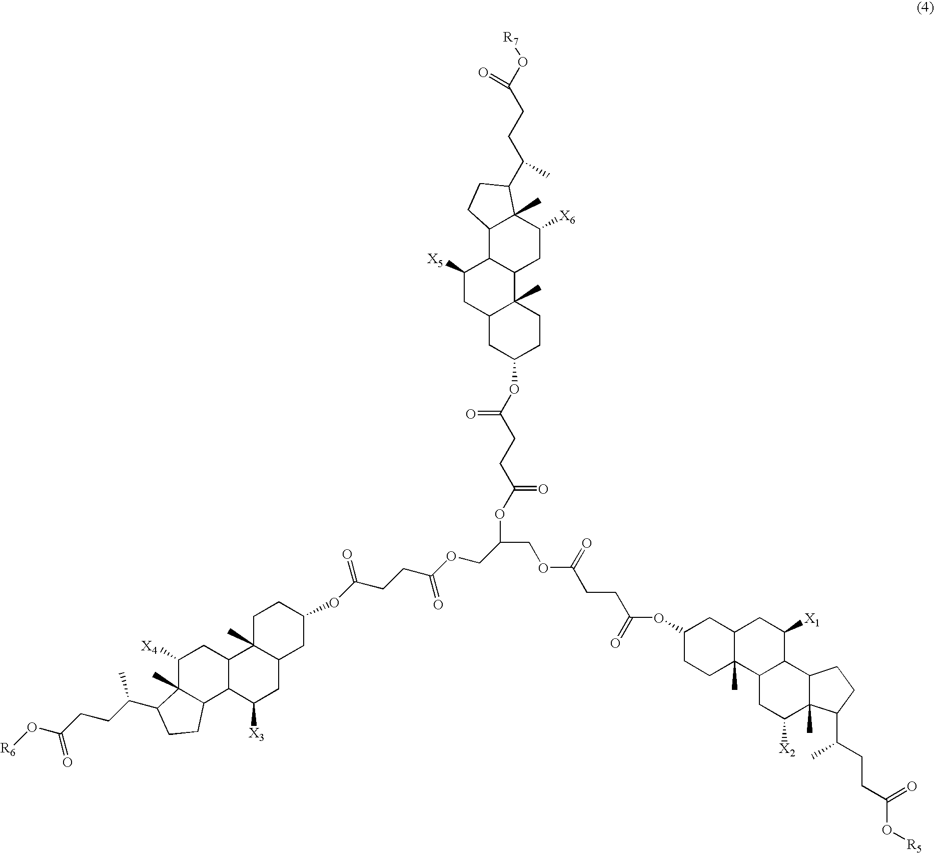 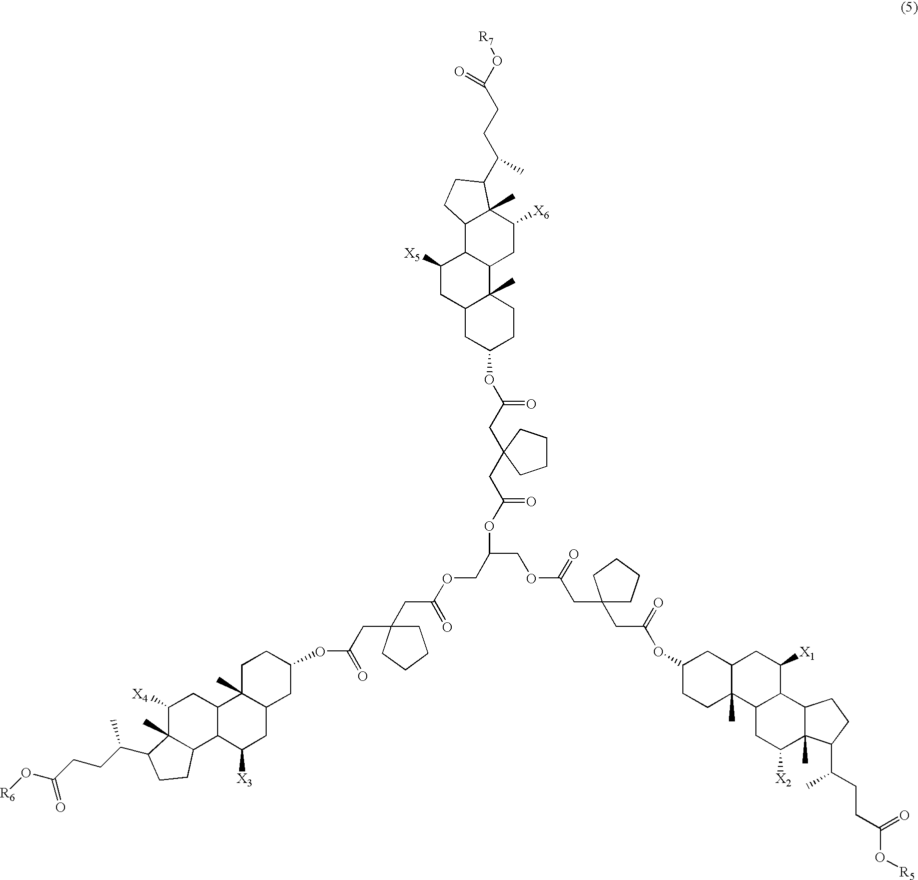 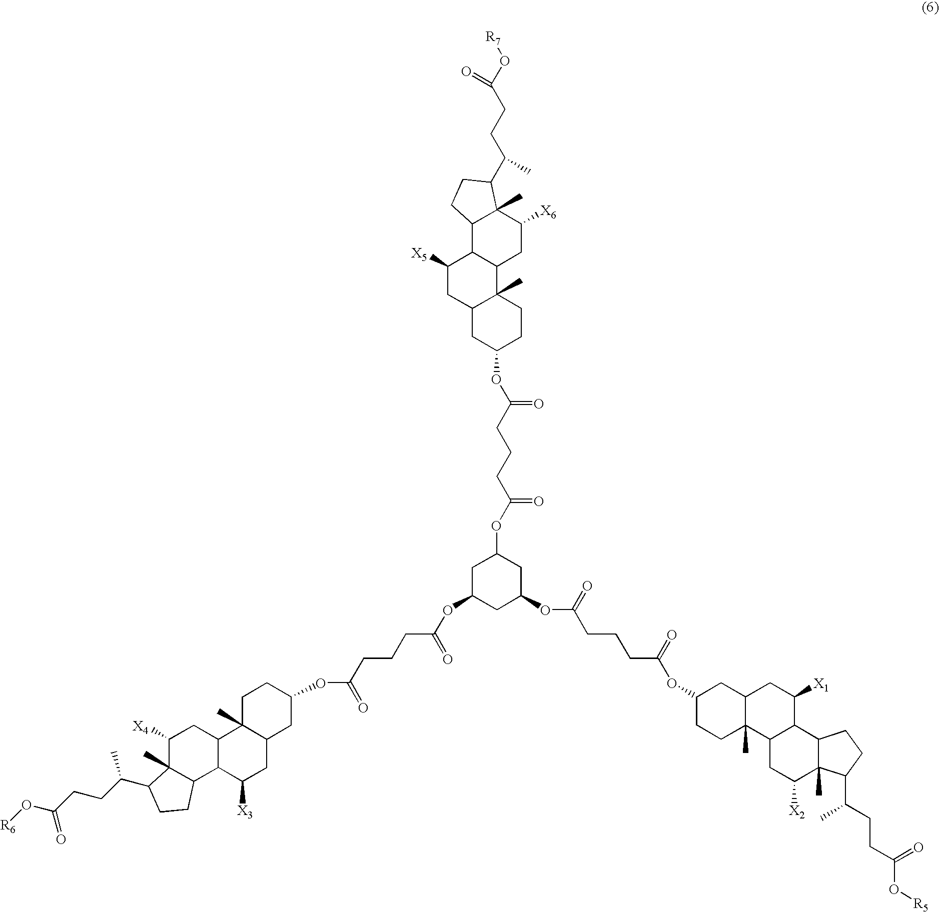 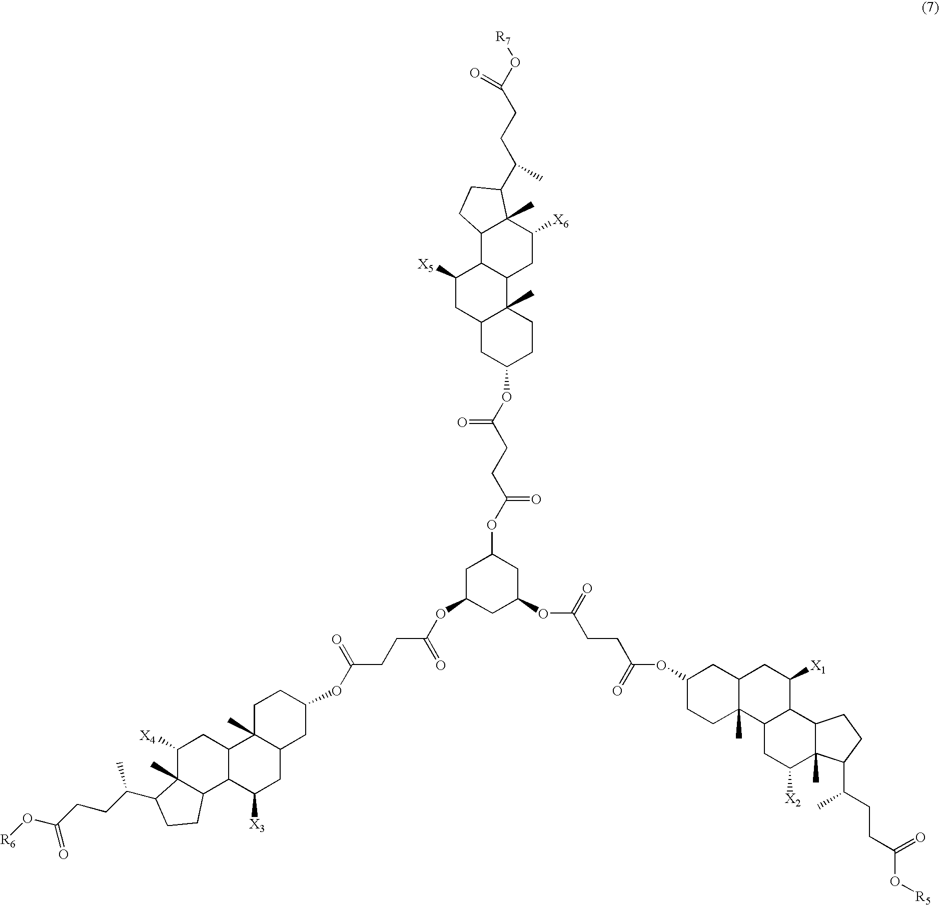 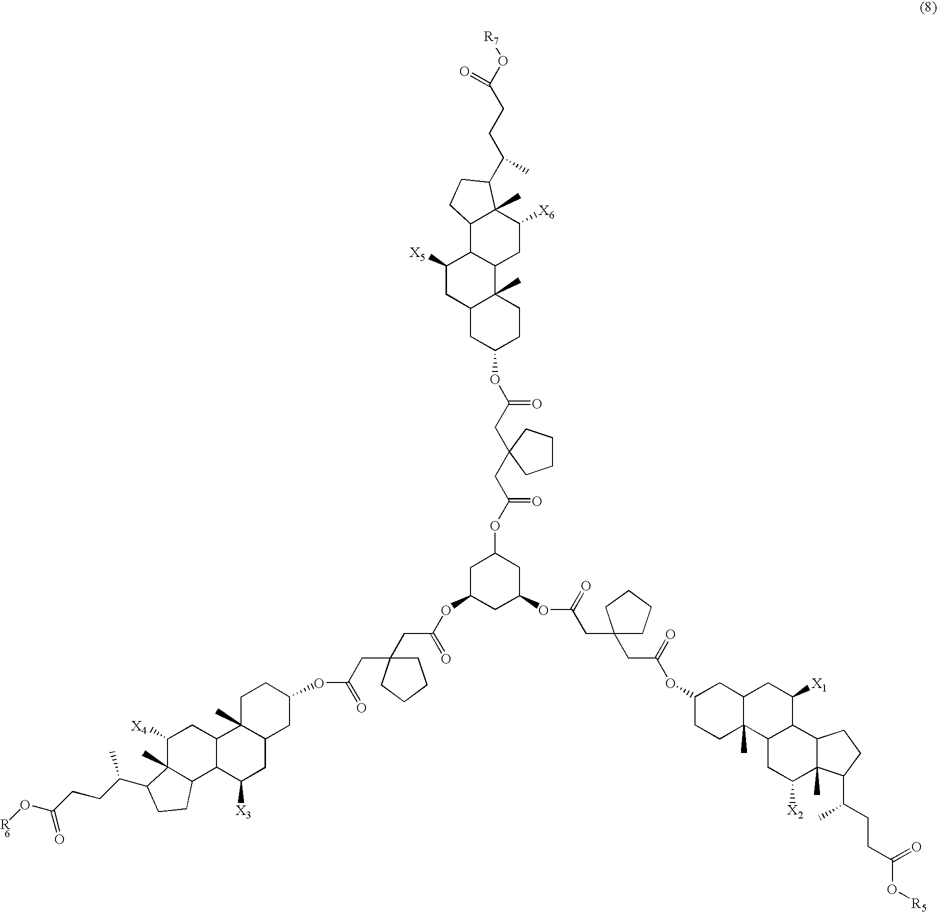 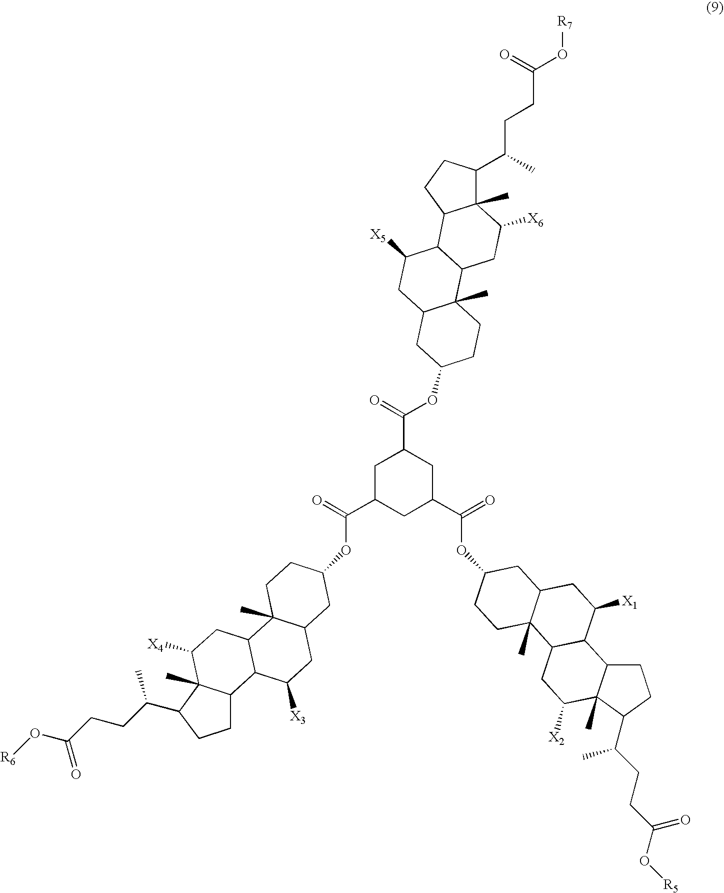
wherein in formulae (3) to (9), R₅, R₆ and R₇ are independently a tert-butyl group, a tetrahydropyranyl group or a 1-ethoxyethyl group, and X₁ to X₆ are independently a hydrogen atom or a hydroxyl group.

7. The photoresist composition of claim 1, wherein the cross-linking agent comprises an aliphatic or cycloaliphatic epoxy compound having substantially less than or equal to about 20 carbon atoms, an aliphatic, cycloaliphatic or aromatic polyol compound having substantially less than or equal to about 20 carbon atoms, or a combination thereof.

8. The photoresist composition of claim 1, wherein the cross-linking agent comprises at least one selected from the group consisting of: 1,4-cyclohexanediol; 1,3,5-cyclohexanetriol; 1,2,4,5-tetrahydoxycyclohexane; hexahydroxycyclohexane; 1,4-benzenediol; 1,3,5-trihydroxybenzene; 1,2,4,5-tetrahydroxybenzene; hexahydroxybenzene; and compounds having chemical structures represented by formulae 11 to 14. 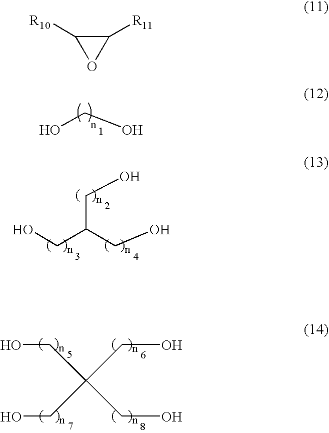
wherein in formula (11), R₁₀ and R₁₁ independently represent hydrogen atom, or an alkyl or cycloalkyl group having substantially less than or equal to about 20 carbon atoms, and wherein in formulae (12) to (14), n₁ represents an integer of 1 to 20, and each of n₂ to n₈ independently represents an integer of 0 to 20.

9. The photoresist composition of claim 1, wherein the photosensitive material comprises at least one selected from the group consisting of a sulfonium salt, a triarylsulfonium salt, an iodonium salt, a diaryliodonium salt, nitrobenzyl ester, disulfone, diazo-disulfone, sulfonate, trichloromethyltriazine and N-hydroxysuccinimide triflate.

10. The photoresist composition of claim 1, wherein the organic solvent comprises at least one selected from the group consisting of ethylene glycol monomethyl ether, ethylene glycol monoethyl ether, propylene glycol methyl ether, methyl cellosolve acetate, ethyl cellosolve acetate, diethylene glycol monomethyl ether, diethylene glycol monoethyl ether, propylene glycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone and 4-heptanone.

11. The photoresist composition of claim 1, further comprising an organic base.

12. The photoresist composition of claim 11, wherein the photoresist composition comprises about 8 to about 20 percent by weight of the compound having the chemical structure represented by formulae (1) or (2), about 1 to about 5 percent by weight of the cross-linking agent, about 0.1 to about 0.5 percent by weight of the photosensitive material, and about 0.1 to about 5 percent by weight of the organic base, based on a total weight of the photoresist composition.

13. The photoresist composition of claim 11, wherein the organic base comprises at least one selected from the group consisting of triethylamine, triisobutylamne, triisooctylamine, triisodecylamine, diethanolamine and triethanolamine.

14. A method of forming a photoresist pattern comprising:
forming a photoresist film on an object by coating the object with a photoresist composition comprising a cross-linking agent including at least one epoxy group and/or at least two hydroxyl groups, a photosensitive material, an organic solvent, and a compound having a chemical structure represented by formulae (1) or (2), 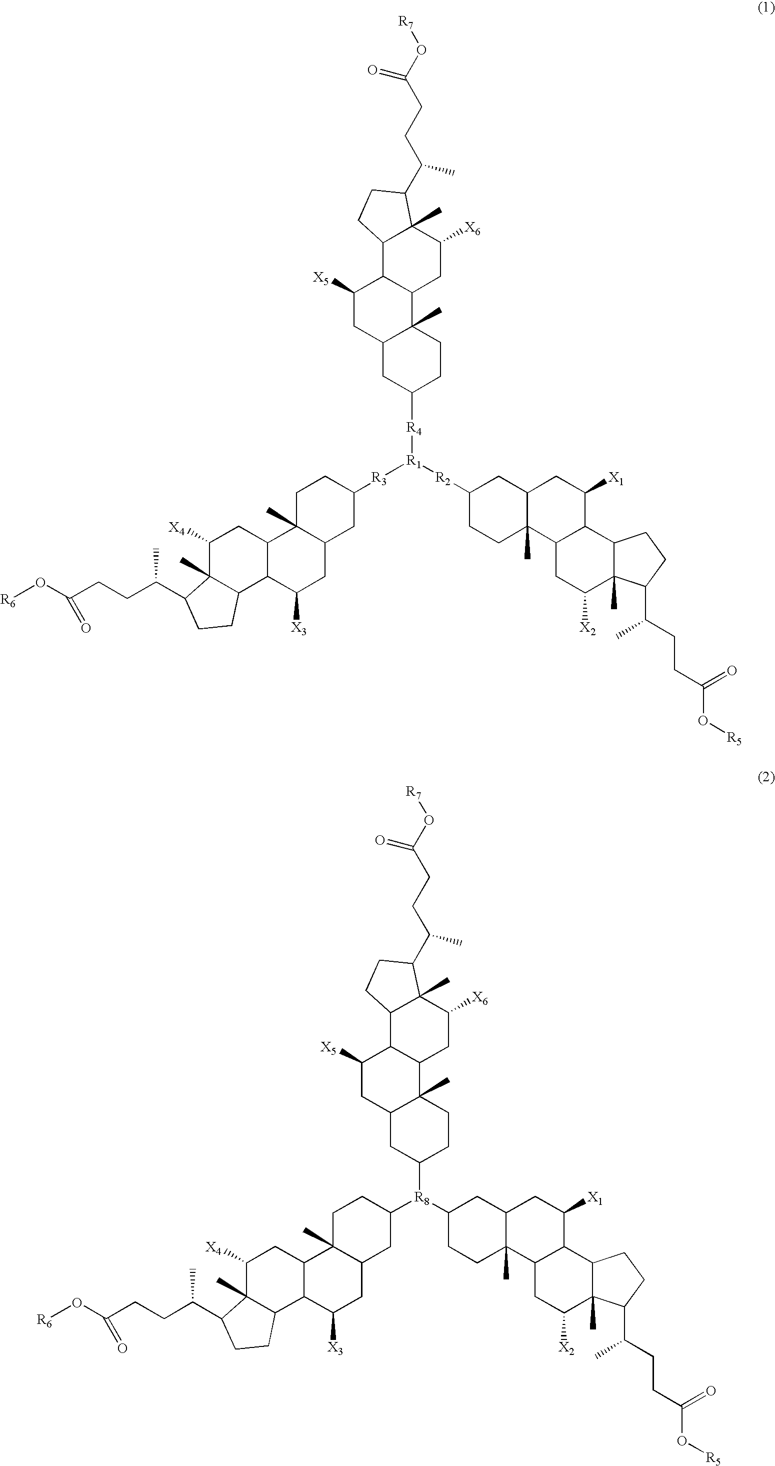
wherein in formulae (1) and (2), R₁ is a triol moiety obtained by removal of three hydrogen atoms from three hydroxyl groups of a triol, R₂, R₃ and R₄ are independently dicarboxylic acid moieties obtained by removal of two hydrogen atoms from two carboxylic groups of a dicarboxylic acid, R₅, R₆ and R₇ are independently a tert-butyl group, a tetrahydropyranyl group or a 1-ethoxyethyl group, R₈ is a tricarboxylic acid moiety obtained by removal of three hydrogen atoms from three carboxylic groups of a tricarboxylic acid, and X₁ to X₆ are independently a hydrogen atom or a hydroxyl group;
exposing the photoresist film to light; and
partially removing the photoresist film from the object to form the photoresist pattern.

15. The method of claim 14, wherein the cross-linking agent comprises an aliphatic or cycloaliphatic epoxy compound having substantially less than or equal to about 20 carbon atoms, an aliphatic, cycloaliphatic or aromatic polyol compound having substantially less than or equal to about 20 carbon atoms, or a combination thereof.

16. The method of claim 14, wherein the light to which the photoresist film is exposed is at least one of a mercury-xenon (Hg—Xe) light, a G-line ray, an I-line ray, a krypton fluoride laser, an argon fluoride laser, an electron beam or an X-ray.

17. The method of claim 14, further comprising a baking of the photoresist film at a temperature of about 90° C. to about 130° C. before exposing the photoresist film to the light.

18. The method of claim 14, further comprising a baking of the photoresist film at a temperature of about 90° C. to about 160° C. after exposing the photoresist film to the light.

19. The method of claim 14, further comprising a first baking of the photoresist film at a temperature of about 90° C. to about 130° C. before exposing the photoresist film to the light, and a second baking of the photoresist film at a temperature of about 90° C. to about 160° C. after exposing the photoresist film to the light.
